(19) United States
(12) Patent Application Publication
(10) Pub. No.: US 2014/0140518 A1
(43) Pub. Date: May 22, 2014

(54) Method and Device for Evaluating Structure-Borne Sound During a Collision of a Vehicle

(71) Applicant: Hoang Trinh, Gerlingen (DE)

(72) Inventor: Hoang Trinh, Gerlingen (DE)

(73) Assignee: Robert Bosch GmbH, Stuttgart (DE)

(21) Appl. No.: 14/008,700

(22) PCT Filed: Feb. 9, 2012
(86) PCT No.: PCT/EP2012/052161

§ 371 Date: Feb. 6, 2014

(30) Foreign Application Priority Data
Apr. 7, 2011 (DE) 10 2011 006 984.4

(51) Int. Cl. B60R 21/013

(52) U.S. Cl. CPC B60R 21/013
USPC 381/56

(57) ABSTRACT

The disclosure relates to a method for evaluating structure-borne sound during a collision of a vehicle. The method includes filtering a structure-borne sound signal which represents a structure-borne sound propagating in the vehicle, having a plurality of filter rules. Each of the filter rules is configured to generate a filtered structure-borne sound signal from the structure-borne sound signal. The method further includes combining the filtered structure-borne sound signals into an evaluation signal.

### PRIOR ART

The present invention relates to a method for evaluating structure-borne sound during a collision of a vehicle, to a corresponding device and to a corresponding computer program product.

Structure-borne sound sensors can be used for detection of a collision of a vehicle.

DE 10 2004 038 984 A1 discloses a device for crash detection using a sensor detecting structure-borne sound.

### DISCLOSURE OF THE INVENTION

Against this background, with the present invention a method for evaluating structure-borne sound during a collision of a vehicle, furthermore a device that uses said method and finally a corresponding computer program product according to the independent claims are presented. Advantageous embodiments are apparent from the respective dependent claims and the subsequent description.

The invention is based on the knowledge that vehicle structures of vehicles are stiffer. The result of this is that the crash requirements are higher. In particular, the frontal vehicle structure is stiffer. As a result of design changes of the crash management system (CMS), the impact energy absorption capacity of the vehicle changes. The crash management system can consist of a bumper, a crash box and a longitudinal bearer of the vehicle. Here the bumper can be linear instead of curved and the crash box can be implemented as rather large instead of small.

A so-called 15 km/h repair crash with a 10° impact angle produces a larger signal compared to an impact angle of 0°, which generates a larger load for the crash management system. Crash functions of the airbag algorithm for a vehicle type without an upfront sensor system (UFS) are secondary here. A system tolerance chain for a structure-borne sound signal is too high for crash discrimination in this case. The system tolerance chain comprises the vehicle tolerance, a mechanical tolerance of the control device ECU and a crash tolerance.

The use of filter banks is therefore suitable for the analysis of structure-borne sound. The use of a filter bank enables on the one hand certain crash specific frequency bands to be weighted separately from each other. On the other hand it enables application-specifically defined frequency bands to be turned off in order to mask resonances of the structure of the vehicle.

Advantageously, switching off the resonant frequency of the vehicle and switching off the resonant frequency of the control device are thus enabled. In comparison to using only a band pass filter that can e.g. be adjusted between 5-20 KHz, an easier and better application, more degrees of freedom and a better signal result. This results in easier discrimination between different types of collision. High frequency signals, which can be caused e.g. by breakage, cutting or deformation of structures of the vehicle, can also be analyzed by means of a filter bank.

The present invention provides a method for the evaluation of structure-borne sound during a collision of a vehicle, which comprises the following steps:

Filtering of a structure-borne sound signal, which represents structure-borne sound propagating in the vehicle, with a plurality of filter rules, wherein each filter rule is designed to generate a filtered structure-borne sound signal from the structure-borne sound signal; and

combining the filtered structure-borne sound signals to form an evaluation signal.

The vehicle can be a motor vehicle, e.g. an automobile. The collision or a crash can represent a collision between the vehicle and an object. Structures of the vehicle are deformed thereby. This causes noise, which is transferred as structure-borne sound by structures of the vehicle. Structure-borne sound can thereby be propagated with a speed of up to 5000 m/s. Structure-borne sound reacts very sensitively to the respective vehicle structure via which the structure-borne sound is propagating, to the hardware of the central control device and to crash tolerances. Thus by means of an analysis of the structure-borne sound a conclusion can be drawn regarding the type of collision causing the structure-borne sound. Structure-borne sound can be recorded with a suitable sensor. The sensor can be part of the central control device or can be disposed at another position of the vehicle structure. An electrical structure-borne sound signal that represents the structure-borne sound can be generated by means of the sensor. The structure-borne sound signal can have a large frequency range corresponding to the underlying structure-borne sound. The entire frequency range of the structure-borne sound signal or a relevant section of the entire frequency range can be divided into the different filter ranges. A frequency band can be associated with each filter range. Thus the filter rules can represent band pass filters. The filter ranges can be at a distance apart or can comprise overlapping edge regions. Thus a frequency range can be filtered out of the structure-borne sound signal by means of each of the filter rules and prepared and processed in the form of the respective filtered structure-borne sound signal independently of other frequency ranges filtered out by the other filter rules. The filtered structure-borne sound signals can be combined without or after further signal processing. The combining can take place by adding the filtered structure-borne sound signals. Thus the evaluation signal can be a summation signal. The evaluation signal can contain information of the original structure-borne sound that is relevant for another signal evaluation. The method can thus be used e.g. for measuring structure-borne sound signals for airbag applications.

Thus each of the filter rules can be assigned a different filter range.

The method can contain a step of converting the structure-borne sound propagating in the vehicle into an electrical signal representing the structure-borne sound signal. The conversion can take place by means of a suitable structure-borne sound sensor, which is designed to convert oscillations caused by the structure-borne sound into an electrical signal. A corresponding sensor can be connected to a structure of the vehicle at a suitable position in order to record structure-borne sound transferred by the structure. In addition, a suitable sensor can be disposed within a control device of the vehicle in order to record structure-borne sound transmitted into the control device.

In a deactivation step at least one of the filter rules can be deactivated. Here the at least one filter rule can have an associated filter range, which includes a resonance range of a structure via which the structure-borne sound is propagating. Thus a filtered structure-borne sound signal can be deactivated for the filter rule whose filter range contains a resonant frequency of the structure. The resonance range can be determined uniquely by suitable tests. The deactivation can take place by switching off a filter element that implements the corresponding filter rule or the corresponding filtered structure-borne sound signal is excluded from further signal processing. If a plurality of separate frequency ranges is to be filtered out, then a plurality of filter rules can also be deactivated. Distortion of the original structure-borne sound signal caused by the resonant behavior of the structure can be prevented in this way.

The method can include a step for adapting the filtered structure-borne sound signal according to an adaptation rule, in order to generate adapted filtered structure-borne sound signals from the filtered structure-borne sound signals. In the combining step the adapted filtered structure-borne sound signals are combined to form the evaluation signal. In this way, certain frequency ranges of the structure-borne sound signal are boosted or damped. Relevant frequency ranges can be accentuated, especially for a subsequent evaluation. A characterization of the collision causing the structure-borne sound is facilitated in this way.

In a setting step the adaptation rule can be adjusted based on information about the expected further course of the collision. The further course of the collision can be determined based on the signals of sensors that already provide information about the collision in advance of a collision or directly following the start of the collision. The adaptation rule can e.g. be adapted according to an expected collision intensity, an expected collision direction or vehicle structures expected to be affected by the collision. This enables adaptation of the signal evaluation and signal processing that is typical of a type of collision. This increases the accuracy of the characterization of the collision causing the structure-borne sound.

According to one embodiment, each filter rule can be assigned a different frequency band. For this purpose, a plurality of different band pass filters can be used. Band pass filters can also be combined with one or more high pass filters or low pass filters. A filter bank can also be used. The individual filter rules can be simply implemented in this way.

The method can include a step of determining a type of collision depending on the evaluation signal. A method for determining the type of the collision based on a structure-borne sound signal caused by the collision is thus provided. Depending on the evaluation signal, this can involve information from the evaluation signal being included in determining the type of the collision.

Thereby the type of the collision can be determined based on a comparison of an acceleration signal with a threshold value during the determination step. The acceleration signal can represent an acceleration of the vehicle. The threshold value can be adjusted based on the evaluation signal. The method can thus be used advantageously in combination with known collision detection methods that evaluate signals of acceleration sensors. Here the characteristic of the structure-borne sound can be used to improve the collision detection accuracy.

The present invention also provides a device for evaluating structure-borne sound during a collision of a vehicle with the following features:

A plurality of filters for filtering a structure-borne sound signal, which represents structure-borne sound propagating in the vehicle, wherein each filter is associated with a different filter range and each filter is designed to generate a filtered structure-borne sound signal from the structure-borne sound signal; and

a combiner that is designed to combine the filtered structure-borne sound signals to form an evaluation signal.

The plurality of filters can be implemented by a filter bank. A use of a filter bank for evaluating structure-borne sound during a collision of a vehicle is thus proposed. The plurality of filters can receive the structure-borne sound signal via an electrical interface to a structure-borne sound sensor or via a mechanical interface to a structure that transfers the structure-borne sound signal. The combiner can be implemented by means of a logic circuit. The combiner can comprise an electrical interface to another signal evaluation unit, via which the combiner can output the evaluation signal. The device can be designed to carry out or implement the steps of the method according to the invention in suitable devices. Also the object of the invention can be achieved rapidly and efficiently by means of said variant of an embodiment of the invention in the form of a device. A device can thus be understood to be an electrical device that processes sensor signals and outputs control signals depending thereon. The device can comprise an interface that can be designed in hardware and/or software form. With a hardware design the interface can be e.g. part of a so-called system ASIC, which contains diverse functions of the device. However, it is also possible that the interfaces are separate, integrated circuits or consist at least partly of discrete components. With a software design, the interface can be software modules that are present e.g. on a microcontroller in addition to other software modules.

A computer program product is also of advantage with program code that can be stored on a machine-readable medium such as a semiconducting memory, a hard disk storage device or an optical memory and is used for carrying out the method according to one of the previously described embodiments, if the program is implemented on a device corresponding to a computer, e.g. a device for evaluating structure-borne sound.

The invention is explained below using the accompanying figures by way of example. In the figures:

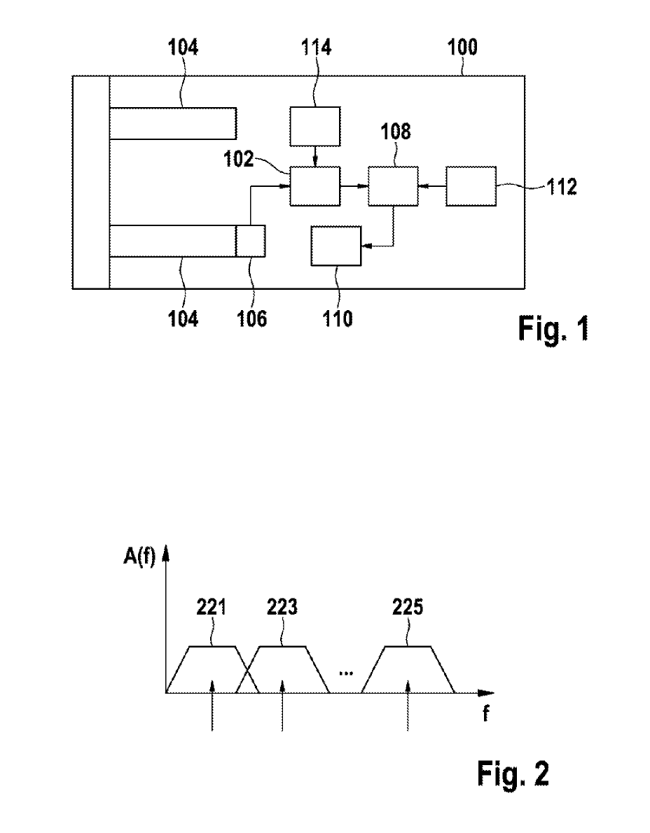

FIG. 1 shows a schematic illustration of a vehicle according to an exemplary embodiment of the present invention;

FIG. 2 shows a schematic illustration of filter rules according to an exemplary embodiment of the present invention;

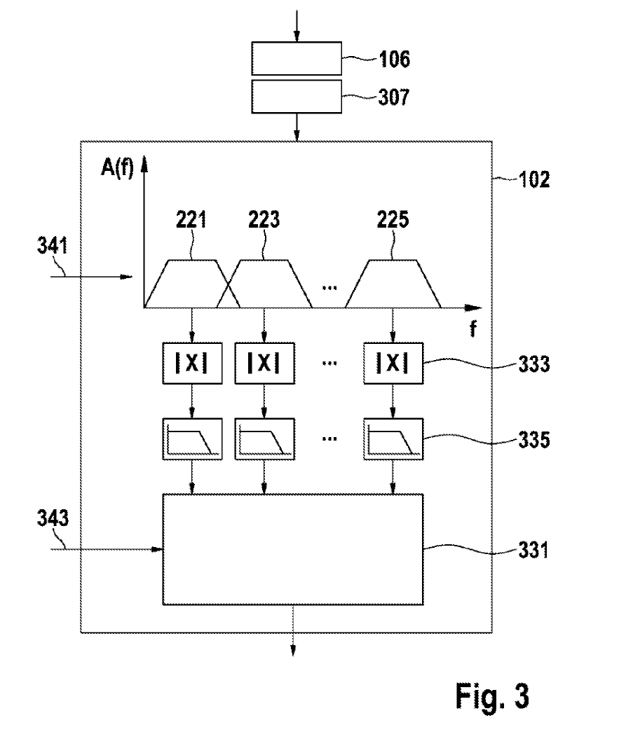

FIG. 3 shows a schematic illustration of a signal chain for evaluating structure-borne sound according to an exemplary embodiment of the present invention;

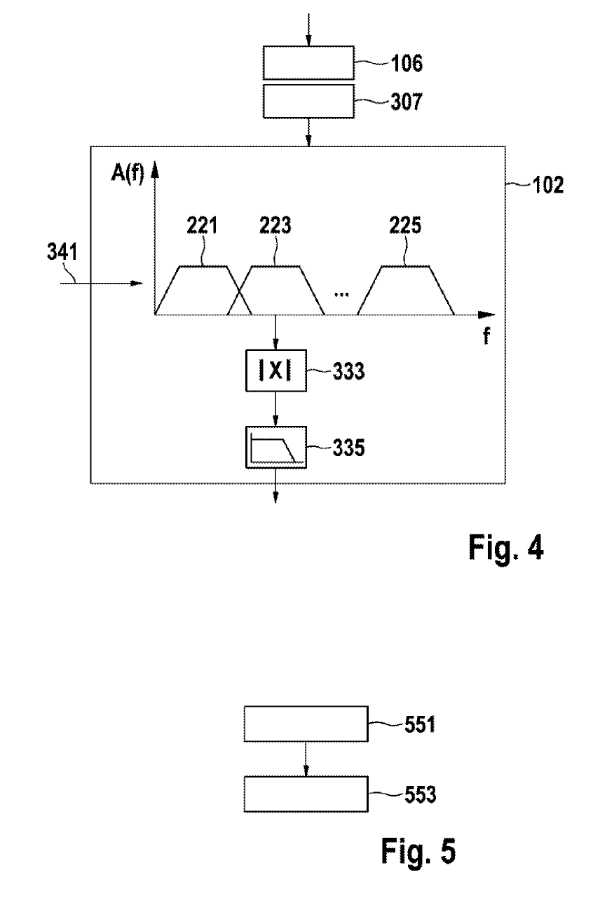

FIG. 4 shows a schematic illustration of a further device for evaluating structure-borne sound according to an exemplary embodiment of the present invention;

FIG. 5 shows a process diagram of a method for evaluating structure-borne sound according to an exemplary embodiment of the present invention.

In the following description, preferred exemplary embodiments of the present invention are used for the elements that are illustrated in the various figures and elements that act similarly and have the same or similar reference characters, wherein a repeated description of said elements is omitted.

FIG. 1 shows a schematic illustration of a vehicle 100 with a device 102 for evaluating structure-borne sound according to an exemplary embodiment of the present invention. A structure of the vehicle consisting of a bumper and two longitudinal bearers 104 is shown schematically. If the vehicle 100 collides with an object in the area of the bumper, then the resulting noise is transferred as structure-borne sound along the bumper and via the longitudinal bearer into the vehicle.

The propagating structure-borne sound can be recorded by means of a structure-borne sound sensor 106, which by way of example is disposed here on a surface of one of the longitudinal bearers. The structure-borne sound sensor 106 is designed to record mechanical oscillations of the structure-borne sound and to convert it into an electrical structure-borne sound signal and to output it via a suitable interface to the device 102 for evaluating the structure-borne sound. The structure-borne sound sensor 106 can also be disposed within a control device of the vehicle 100.

The device 102 comprises a plurality of filters, to each of which the structure-borne sound signal is delivered. Each filter is designed to allow a certain frequency range of the structure-borne sound signal to pass and to output a filtered structure-borne sound signal that contains only the corresponding frequency range in each case. The individual filtered structure-borne sound signals are combined to form an evaluation signal. For this purpose the device 102 can comprise a suitable combiner. The device 102 is designed to output the evaluation signal via a suitable interface to a classifying device 108.

The classifying device 108 is designed to classify the collision. The collision can be classified by means of the classification, e.g. in relation to a collision intensity and a type of collision. Control of an occupant protection means 110, e.g. an airbag, can take place depending on the classification. For this purpose the classifying device 108 can be designed to provide an activation signal for activating the occupant protection means 110 based on the classification to the occupant protection means 110 via a suitable interface.

According to one exemplary embodiment, the classifying device 108 is designed to classify the collision based only on the evaluation signal of the device 102.

According to another exemplary embodiment, the classifying device 108 is designed to classify the collision based on the evaluation signal and based on an acceleration signal of an acceleration sensor 112. The acceleration sensor 112 is designed to record an acceleration of the vehicle, e.g. in the longitudinal direction and additionally or alternatively in the lateral direction and to provide corresponding information to the classifying device 108. The classifying device 108 is designed to analyze the information according to an analysis rule in order to classify the collision. The classifying device 108 is designed to adapt the analysis rule based on the evaluation signal. For example, the analysis rule can include a threshold comparison. A threshold of such a threshold comparison can be adjusted depending on the evaluation signal. For example, the threshold value can be adjusted depending on a value or a time profile of the evaluation signal.

According to an exemplary embodiment, the filters and additionally or alternatively the combiner of the device 102 can be implemented adjustably. Corresponding adjustments can be implemented by an adjustment device 114, which is connected to the device 102 by a suitable interface. The adjustment device 114 can be designed to deactivate one or more of the filters of the device 102. For this purpose the adjustment device 114 can output a suitable deactivation signal to the device 102. The adjustment device 114 can be designed to set a type of the combination of the filtered structure-borne sound signals to form the evaluation signal. The adjustment device 114 can also be designed to set a weighting, with which the filtered structure-borne sound signals are weighted during the combination. For this purpose, the adjustment device 114 can provide a suitable adjustment signal to the device 102. Suitable adjustment values, based on which the adjustment device 114 carries out the adjustment of the device 102, can be permanently stored in the adjustment device 114. If the adjustment device 114 has a user interface, e.g. to a programming device, then the adjustment values can be entered by a user into the adjustment device 114 and stored by the adjustment device 114. In this way, the adjustment values can be adapted, e.g. to the vehicle structure of the vehicle. According to one exemplary embodiment, the adjustment device 114 is designed to set an adjustment value based on current vehicle information. Current information can include a vehicle speed or sensor information, e.g. of the acceleration sensor 112. In this way, e.g. current driving parameters or already available information about the collision can be included in the evaluation of the structure-borne sound signal in the device 102.

Some or all of the elements 102, 106, 108, 112, 114 can be disposed in a controller of the vehicle 100.

Exemplary embodiments of a spectral density evaluation, which can be implemented e.g. in the device 102 shown in FIG. 1, are described using FIGS. 2 through 4.

FIG. 2 shows a schematic illustration of filter rules 221, 223, 225 according to an exemplary embodiment of the present invention. The filter rules 221, 223, 225 are shown as representative of a plurality of N filter rules. Each filter rule 221, 223, 225 has a dedicated associated frequency band that is different from the frequency bands of the other filter rules 221, 223, 225. This is shown by an illustration of the filter rules 221, 223, 225 in a diagram, on whose abscissa the frequency f of a structure-borne sound signal and on whose ordinate the amplitude A(f) of the structure-borne sound signal are plotted. Each of the filter rules 221, 223, 225 is programmable, which is indicated by the arrows pointing to the filter rules 221, 223, 225. Each of the filter rules 221, 223, 225 can be implemented by a band pass filter, which can comprise a suitable programming input. In particular, each of the filter rules 221, 223, 225 can be activated and deactivated independently of the other filter rules 221, 223, 225.

FIG. 3 shows a schematic illustration of a signal chain for evaluating structure-borne sound according to an exemplary embodiment of the present invention. This shows a structure-borne sound sensor 106, an analogue to digital converter 307 and a device 102 for evaluating structure-borne sound during a collision, e.g. of the vehicle shown in FIG. 1.

A collision-induced acceleration of the vehicle is caused by the collision. Furthermore, the collision causes structure-borne sound with a frequency f of about 5-20 kHz. The structure-borne sound can be recorded by the structure-borne sound sensor 106. The structure-borne sound sensor 106 can be a CMB sensor comprising a MEMS detection element (MEMS=Micro-Electro Mechanical System). An analogue signal generated by the structure-borne sound sensor 106 can be converted by the analogue to digital converter 307 into a digital signal and output to the device 102 as a structure-borne sound signal.

The device 102 can be implemented as an ASIC or as a logic element of an ASIC. The device 102 is designed to receive the structure-borne sound signal from the analogue to digital converter 307, to carry out signal processing and as the result of the signal processing to output an evaluation signal in the form of an SBS signal. The device 102 comprises a band pass filter bank with N band pass filters 221, 223, 225. The structure-borne sound signal is provided to the band pass filters 221, 223, 225 and is filtered by the band pass filters 221, 223, 225. Each of the band pass filters 221, 223, 225 generates a filtered structure-borne sound signal according to its filter characteristic. The filtered structure-borne sound signals are combined by a combiner 331 into the evaluation signal. According to said exemplary embodiment, the filtered structure-borne sound signals, following their output by the band pass filters 221, 223, 225, are each subjected to absolute value formation by devices 333 and to low pass filtering by low pass devices 335 before the filtered structure-borne sound signals are delivered to the combiner 331. The combiner 331 is designed to sum the filtered structure-borne sound signals. For example, the combiner 331 can be designed to implement the functions Sum_Mode(Lin/Log) or Sign_Sum_mode.

According to said exemplary embodiment, the device 102 comprises two other inputs 341, 343. The filter bank can deliver an activation signal for activation or deactivation of the band pass filters 221, 223, 225 via one of the inputs 341. The activation signal can be implemented as an EnableBPFlag, e.g. in the form [1 1 0 . . . 1]. A flag can be assigned to each band pass filter 221, 223, 225 that defines an activation state of the respective band pass filter 221, 223, 225. Depending on how the individual flags are set or are set by the activation signal, the band pass filters 221, 223, 225 can be activated or deactivated mutually independently. If a band pass filter 221, 223, 225 is deactivated, it does not generate a filtered structure-borne sound signal. An adjustment signal, with which a combination mode of the combiner 331 can be set, can be delivered to the combiner 331 via the other input 343. The adjustment signal can be implemented as an EnableBPLogicMode signal, with which a corresponding logic mode of the combiner 331 can be enabled.

The use of filter banks results in an improved concept for the band pass path. At least three band pass filters are used here to cover the entire frequency range, instead of using only one band pass filter.

According to one exemplary embodiment, a first band pass filter bp1 can have a frequency range of 5-10 kHz, a second band pass filter bp2 can have a frequency range of 10-15 kHz and a third band pass filter bp3 can have a frequency range of 15-20 kHz. A relevant frequency range between 5 kHz and 20 kHz can thus be covered with three band pass filters. The band pass filters bp1, bp2, bp3 can be the band pass filters 221, 223, 225 shown in FIG. 3.

According to another exemplary embodiment, a first band pass filter bp1 can have a frequency range of 5-9 kHz, a second band pass filter bp2 can have a frequency range of 9-13 kHz, a third band pass filter bp3 can have a frequency range of 13-17 kHz and a fourth band pass filter bp4 can have a frequency range of 17-20 kHz.

According to another exemplary embodiment, a band pass filter bank with any number of N band pass filters can be used.

Each filter bank can be activated or deactivated for a further evaluation. Using specific programmable logic settings, a different strategy for evaluation of filter banks can be used. Using a Sum_Mode the signals of the band pass filters of the filter bank can be summed.

This means that the filtered structure-borne sound signals of the individual band-pass filters are weighted, i.e. are summed exponentially, logarithmically or linearly. According to a Sign_Sum_Mode, each filter bank has a sign for the summation, i.e. sgn_bp1=sgn_bp2=sgn_bpN/2=1; sgn_bpN/2+1=−1= . . . =sgn_bpN=−1. This means that the filtered structure-borne sound signals of the individual band pass filters are each provided with a sign before the summation.

The use of a specific deactivation of a filter of a filter bank is thus possible. According to one exemplary embodiment, the band pass filter bp2 223 should be insensitive to a structural resonance characteristic of the controller ECU. The structural resonance characteristic of the airbag ECU can vary markedly because of differently constructed parts, such as plastic, aluminum housings or connecting elements. As effects of the structural resonance characteristic can be removed by deactivating one or more filters, the focus can be on a crash-specific spectrum for supporting crash discrimination. The weighting, i.e. an exponential, logarithmic or linear profile of the weighting against frequency, plays a certain role with respect to calibration robustness. A lower weighting can be selected for higher frequencies because of higher tolerances. Low frequencies can, however, be weighted more strongly.

As shown in FIG. 3, a defined function can be assigned to each band pass 221, 223, 225. The defined function can be a weighting function. The weighting function can be linear, can include absolute value formation, can change sign, can include the application of an offset, can be constant or can be logarithmic. As a result only one signal remains. As in FIG. 3, said signal can be the result of the summation by the sum mode in the combiner 331. Said signal can then be input into the trigger algorithm. A separate absolute value filter 333 and low pass filter 335 can also be connected downstream for each channel.

FIG. 4 shows a schematic illustration of a signal chain for evaluating structure-borne sound according to another exemplary embodiment of the present invention. The signal chain corresponds to the signal chain shown in FIG. 3 with the difference that no combiner is provided. According to said exemplary embodiment, the filtered structure-borne sound signal of the band pass filter 223, after absolute value formation and low pass filtering, is directly output by the device 102 as an evaluation signal in the form of the SBS signal.

According to the exemplary embodiment shown in FIG. 3, a filter bank 221, 223, 225 is used instead of a single band pass filter. The application of specific deactivation of a filter bank can be implemented. For example, the band pass filter bp2 223 can be insensitive to the structural resonance characteristic of the ECU in its frequency range.

As shown in FIG. 4, selection of the band pass can only be controlled by an absolute value/filter function.

FIG. 5 shows a process diagram of a method for evaluating structure-borne sound according to an exemplary embodiment of the present invention. In a step 551, a structure-borne sound signal is filtered with a plurality of filter rules in order to generate a plurality of filtered structure-borne sound signals. The filtering can be carried out with a filter bank, as described e.g. using FIGS. 2 to 4. In a step 553 the filtered structure-borne sound signals are combined into an evaluation signal. The combining can be carried out with a combining device, as is shown e.g. in FIG. 3.

The evaluation signal can e.g. be further processed by a core algorithm of a trigger algorithm for an occupant protection means. A corresponding trigger algorithm comprises the core algorithm, which is based on central x/y sensors and a core threshold. The x/y sensors can be acceleration sensors that sense in the longitudinal direction and in the lateral direction of the vehicle. The core threshold can specify a trigger threshold. Triggering of an occupant protection means can take place if the trigger threshold exceeds the core threshold by a signal provided by the x/y sensors or a signal determined therefrom. The trigger algorithm also comprises an additional function. According to the additional function, an adaptation of the core threshold is carried out based on peripheral sensors or SBS sensors (SBS=structure-borne sound). For this purpose, the SBS signal provided by the devices 102 shown in FIGS. 3 and 4 can be used.

According to one exemplary embodiment, a plurality of band pass filters is used to provide the structure-borne sound signal accordingly. Each band pass filter is programmable or adjustable. Furthermore, each band pass filter can be switched on and switched off. Each band pass filter can also be weighted linearly or logarithmically. For example, a shake test can be carried out, whereby the control device is shaken in order to identify the resonant frequency of the control device. The band pass filter can then turn off the frequency band containing the resonant frequency.

The exemplary embodiments described and shown in the figures are only selected by way of example. Different exemplary embodiments can be combined with each other completely or in relation to individual features. An exemplary embodiment can also be expanded by features of another exemplary embodiment. Furthermore, process steps according to the invention can be repeated and can be carried out in a sequence other than the described sequence.

1. A method for evaluating structure-borne sound during a collision of a vehicle, comprising:
filtering of a structure-borne sound signal, which represents structure-borne sound propagating in the vehicle, with a plurality of filter rules, each filter rule of the plurality of filter rules being configured to generate a filtered structure-borne sound signal from the structure-borne sound signal; and
combining the filtered structure-borne sound signals into an evaluation signal.

2. The method as claimed in claim 1, wherein a different filter range is associated with each filter rule of the plurality of filter rules.

3. The method as claimed in claim 1 further comprising:
converting the structure-borne sound propagating in the vehicle into an electrical signal representing the structure-borne sound signal.

4. The method as claimed in claim 1 further comprising:
deactivating at least one filer rule of the plurality of filter rules,
wherein a filter range that contains a resonance range of a structure via which the structure-borne sound is propagating is associated with the at least one filter rule.

5. The method as claimed in claim 1 further comprising:
adapting the filtered structure-borne sound signals according to an adaptation rule in order to generate adapted filtered structure-borne sound signals from the filtered structure-borne sound signals; and
combining the adapted filtered structure-borne sound signals into the evaluation signal during the combining the filtered structure-borne sound signals.

6. The method as claimed in claim 5 further comprising:
adjusting the adaptation rule based on information about the expected further course of the collision.

7. The method as claimed in claim 1, wherein a different frequency band is associated with each filter rule of the plurality of filter rules.

8. The method as claimed in claim 1 further comprising:
determining a type of the collision depending on the evaluation signal.

9. The method as claimed in claim 8, wherein:
during the determining the type of the collision, the type of the collision is determined based on a comparison of an acceleration signal with a threshold value,
the acceleration signal represents an acceleration of the vehicle, and
the threshold value is adjusted based on the evaluation signal.

10. A device for evaluating structure-borne sound during a collision of a vehicle comprising:
a plurality of filters configured to filter a structure-borne sound signal, which represents structure-borne sound propagating in the vehicle, a different filter range is associated with each filter of the plurality of filters and each filter of the plurality of filters is configured to generate a filtered structure-borne sound signal from the structure-borne sound signal; and
a combiner configured to combine the filtered structure-borne sound signals into an evaluation signal.

11. A computer program product with program code, which is stored on a non-transitory machine-readable storage medium, for carrying out a method for evaluating structure-borne sound during a collision of vehicle, the method comprising:
filtering a structure-borne sound signal, which represents structure-borne sound propagating in the vehicle, with a plurality of filter rules, each filter rule of the plurality of filter rules being configured to generate a filtered structure-borne sound signal from the structure-borne sound signal; and
combining the filtered structure-borne sound signals into an evaluation signal.
